(19) United States
(12) Patent Application Publication
(10) Pub. No.: US 2026/0144285 A1
(43) Pub. Date: May 28, 2026

(54) A CONSUMABLE

(71) Applicant: NICOVENTURES TRADING LIMITED, London (GB)

(72) Inventor: John RICHARDSON, London (GB)

(21) Appl. No.: 19/120,309

(22) PCT Filed: Oct. 20, 2023
(86) PCT No.: PCT/GB2023/052744

§ 371 Date: Apr. 11, 2025

(30) Foreign Application Priority Data
Oct. 21, 2022 (GB) 2215646.7

(51) Int. Cl. A24D 1/20; A24B 15/167; A24D 1/00; A24F 40/20; A24F 40/465; H05B 6/10

(52) U.S. Cl. CPC A24D 1/20; A24B 15/167; A24D 1/002; A24F 40/20; A24F 40/465; H05B 6/108

(57) ABSTRACT

A consumable for use with a device for heating aerosol-generating material to volatilize at least one component of the aerosol-generating material. The consumable includes an outer tube, an inner member inside the outer tube, and at least one support that supports the inner member relative to the outer tube so that at least one air gap exists between the inner member and the outer tube. At least one of the inner member and the outer tube includes aerosol-generating material that is heatable to generate aerosol in the at least one air gap, and the other of the inner member and the outer tube includes a condensation prevention layer configured to prevent aerosol-generated in the at least one air gap from condensing on the other of the inner member and the outer tube.

### RELATED APPLICATIONS

The present application is a National Phase entry of PCT Application No. PCT/GB2023/052744 filed Oct. 20, 2023, which claims priority to GB Application No. 2215646.7 filed Oct. 21, 2022, each of which is hereby incorporated by reference in their entirety.

### TECHNICAL FIELD

The present invention relates to a consumable for use with an aerosol provision system, and aerosol provision system comprising the consumable.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate. Such tobacco industry products commonly include consumables containing aerosol generating material for use in a heating device.

### SUMMARY

In a first aspect of the present invention, there is provided a consumable for use with a device for heating aerosol-generating material to volatilize at least one component of the aerosol-generating material, wherein the consumable comprises: an outer tube; an inner member inside the outer tube, and at least one support that supports the inner member relative to the outer tube so that at least one air gap exists between the inner member and the outer tube; wherein at least one of the inner member and the outer tube comprises aerosol-generating material that is heatable to generate aerosol in the at least one air gap, and wherein the other of the inner member and the outer tube comprises a condensation prevention layer configured to prevent aerosol-generated in the at least one air gap from condensing on the other of the inner member and the outer tube.

In some embodiments, the consumable may further comprise at least one outlet for permitting the aerosol to pass out of the consumable from the air gap.

In some embodiments, the at least one outlet may be at an axial end of the consumable.

In some embodiments, the condensation prevention layer may comprise a porous containment material.

In some embodiments, the porous containment material may comprise one or more materials selected from the group consisting of: wadding, fleece, non-woven material, non-woven fleece, woven material, knitted material, nylon, foam, polystyrene, polyester, polyester filament, polypropylene, and a blend of polyester and polypropylene.

In some embodiments, the condensation prevention layer may comprise a hydrophobic surface.

In some embodiments, the condensation prevention layer may comprise an innermost surface of the outer tube.

In some embodiments, the condensation prevention layer may comprise an outermost surface of the inner member.

In some embodiments, the at least one support may be located between the inner member and the outer tube.

In some embodiments, the at least one support may comprise an annular non-circular support between the inner member and the outer tube.

In some embodiments, the at least one support may comprise a folded or corrugated element between the inner member and the outer tube.

In some embodiments, at least one of the inner member and the outer tube may comprise a carrier, and the aerosol generating material may be affixed to the carrier.

In some embodiments, the aerosol-generating material may be a film provided on the carrier.

In some embodiments, at least one of the inner member and the outer tube may be circular.

In some embodiments, the inner member and the outer tube may be concentric.

In some embodiments, the inner member may comprise an inner tube.

In some embodiments, the inner tube may be located around a passageway that opens at an axial end of the consumable so that a heating element for heating the aerosol generating material is insertable into the passageway in use.

In some embodiments, the consumable may further comprise heating material that is heatable by penetration with a varying magnetic field to thereby heat the aerosol generating material.

In some embodiments, at least one of the inner member and the outer tube may comprise the heating material.

In a second aspect of the present invention, there is provided a system for heating aerosol-generating material to volatilize at least one component of the aerosol generating material, the system comprising: the consumable of any one of the preceding claims, and a device for heating the aerosol-generating material of the consumable to volatilize at least one component of the aerosol-generating material, the device comprising a heating zone for receiving the consumable, and a heater for causing heating of the aerosol generating material when the consumable is in the heating zone.

In some embodiments, the device may comprise a magnetic field generator for generating a magnetic field for penetrating the heating zone when the consumable is in the heating zone.

### BRIEF DESCRIPTION OF THE DRAWINGS

Embodiments of the invention will now be described, by way of non-limiting examples only, with reference to the accompanying drawings, in which:

FIG. 1 shows a schematic cross-sectional end view of a consumable;

FIG. 2 shows a schematic cross-sectional side view of a consumable;

FIG. 3 shows a schematic cross-sectional end view of a consumable;

FIG. 4 shows a schematic cross-sectional side view of a consumable;

FIG. 5 shows a schematic cross-sectional side view of a consumable; and

FIG. 6 shows a schematic view of a system including a consumable and an aerosol provision device.

### DETAIL DESCRIPTION

As used herein, the term “delivery system” is intended to encompass systems that deliver at least one substance to a user, and includes: non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an aerosol-generating material heating system, also known as a heat-not-burn system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid, or gel and may or may not contain nicotine. IN some embodiments, the hybrid system comprises a liquid or gel aerosol-generating material and a solid aerosol-generating material. The solid aerosol-generating material may comprise, for example, tobacco or a non-tobacco product.

The non-combustible aerosol provision systems described herein comprise a non-combustible aerosol provision device and a consumable for use with the non-combustible aerosol provision device.

This disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, and aerosol generation area, a hosing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In one embodiment the active substance is a legally permissible recreational drug

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

The active substance may be CBD or a derivative thereof

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise one or more active substances and/or flavors, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating material may comprise more than one film, and the thickness described herein may refer to the aggregate thickness of those films.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilize at least some of the solvent to form the aerosol-generating film.

The slurry may be heated to remove at least about 60 wt %, 70 wt %, 80 wt %, 85 wt % or 90 wt % of the solvent.

The aerosol-generating material may comprise or be an “amorphous solid”. In some embodiments, the aerosol-generating material comprises an aerosol-generating film that is an amorphous solid.

The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 50 wt %, 60 wt % or 70 wt % of amorphous solid, to about 90 wt %, 95 wt % or 100 wt % of amorphous solid.

The amorphous solid may be substantially free from botanical material. The amorphous solid may be substantially tobacco free.

The aerosol-former material may comprise one or more constituents capable of forming an aerosol. In some embodiments, the aerosol-former material may comprise on or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise on or more of pH regulators, coloring agents, preservatives, binders, fillers, stabilizers, and/or antioxidants.

The aerosol generating material may be present on or in a support, the support forming a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A susceptor is a material that is heatable by penetration with a carrying magnetic field, such as an alternating magnetic field. The susceptor may be an electrically conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread, or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

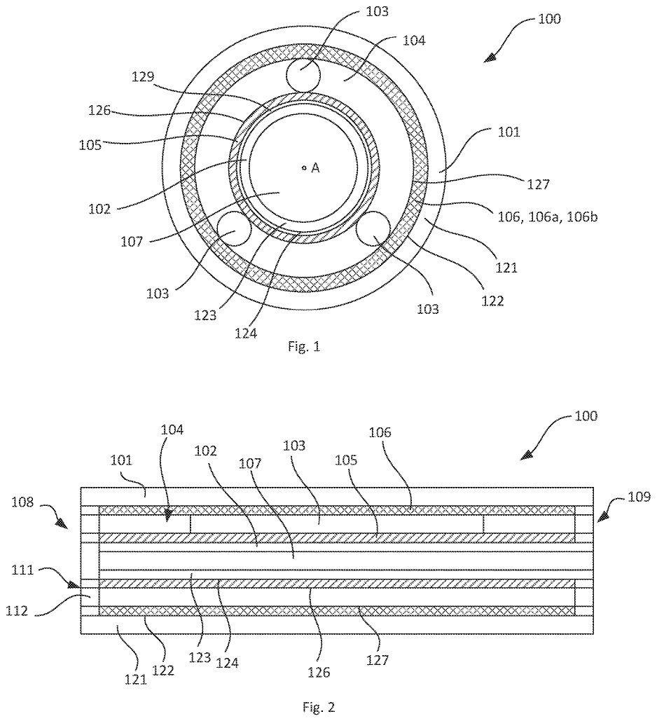

Referring to FIG. 1 and FIG. 2, there are shown a schematic end view and a schematic cross-section side view of an example of a consumable 100 according to an embodiment of the invention. The consumable 100 is for use with an aerosol provision device 200 for heating aerosolizable material to volatilize at least one component of the aerosolizable material, such as the device 200 shown in FIG. 6 and described below.

The consumable 100 comprises an outer tube 101 and an inner member 102 inside the outer tube 101. The consumable 100 further comprises at least one support 103. The at least one support 103 supports the inner member 102 relative to the outer tube 101 so that at least one air gap 104 exist between the inner member 102 and the outer tube 101.

At least one of the inner member 102 and the outer tube 101 comprises an aerosol-generating material 105 that is heatable to generate aerosol in the at least one air gap 104. The other of the inner member 102 and the outer tube 101 comprises a condensation prevention layer 106 configured to prevent aerosol generated in the at least one air gap 104 from condensing on the other of the inner member 102 and the outer tube 101.

The at least one support 103 may connect the inner member 102 to the outer tube 101. In some embodiments, the inner member 102 may comprise a hollow inner tube 102. The hollow inner tube 102 may define a passageway 107 therein. The passageway 107 may open at an axial end 108, 109 of the consumable 100 so that a heating element (not shown in FIG. 1 or FIG. 2, for heating the aerosol generating material is insertable into the passageway 107 in use. The consumable 100 may have two axial ends 108, 109. One axial end may be a downstream or mouth end 108 configured to be placed in a user's mouth when they inhale on the consumable 100. On axial end may be an upstream end 109 that is located at the opposite end of the consumable 100 to the mouth end 108. However, in other embodiments, the inner member 102 may be other than tubular, such as solid rod-shaped.

The consumable 100 of the present embodiment has circular inner and outer cross-sectional shapes. Moreover, the outer tube 101 is circular. In addition, the inner member 102 is circular. In other embodiments, one or each of the outer tube 101 and the inner member 102 may be non-circular, such as, elliptical, polygonal, rectangular, square, triangular, or star-shaped. In some embodiments, the outer tube 101 and/or inner member 102 may be corrugated.

The consumable 100 of the present embodiment extends along an axis A. The axis A is a central axis that extends along the length of the consumable 100. In the present embodiment, the consumable 100 is elongate in the direction of the axis A, but in other embodiments, a width or diameter of the consumable 100 may be greater than or equal to a dimension of the consumable 100 in the direction of the axis A, so that the consumable 100 is not elongate.

In the present embodiment, the inner member 102 and the outer tube 101 are substantially concentric, each with a center that lies of the axis A. However, in other embodiments, the inner member 102 may be non-concentric with the outer tube 101, and the center of one or each of the inner member 102 and the outer tube 101 may be spaced from the axis A.

As shown in FIG. 1 and FIG. 2, the consumable 100 comprises at least one support 103. The at least one support 103 may be located between the inner member 102 and the outer tube 101. In the present embodiment, the consumable 100 comprises three supports 103. However, it will be appreciated that the consumable 100 may comprise more or fewer supports 103. The supports 103 may be circumferentially spaced apart from each other by air gaps 104. In some embodiments the supports 103 may extend along the full length of the consumable 100. In some embodiments, the supports 103 may only extend along part of the length of the consumable 100.

In the present embodiment, the supports 103 are shown as circular elements. However, it will be appreciated that in an alternative embodiment, the at least one support 103 may have a different cross-section, for example, but not limited to, triangular, rectangular, or dome shaped or bell-shaped.

In some embodiments, the at least one support 103 may comprise an annular non-circular support between the inner member 102 and the outer tube 101. In some embodiments, the at least one support 103 may comprise a folded element between the inner member 102 and the outer tube 101. In some embodiments, the at least one support 103 may comprise a corrugated element between the inner member 102 and the outer tube 101.

In some embodiments, the at least one support 103 may be configured as an extension of the inner member 102 to give a rounded triangular shape formed by the inner member 102 and at least one support 103 within the outer tube 101.

In some embodiments, the at least one support 103 may additionally or alternatively comprise a component 111 located at an axial end of the consumable 100. The component 111 may, for example, be located abutting axial end faces of the outer tube 101 and the inner member 102, or two supports may be located at respective axial ends 108, 109 of the outer tube 101 and the inner member 102. Such components 111 may be end pieces. The components 111 may be made of any suitable material, such as, for example, cellulose acetate, paper, a combination of cellulose acetate and paper, any fibrous material with an open structure, such as PLA, polypropylene, non-woven cellulose, or open cell foam, or plastic material. The end pieces may have features for receiving the outer tube 101 and the inner member 102, respectively, and be configured to hold the inner member 102 relative to the outer tube 101.

The supports 103 may extend from the inner member 102 to the outer tube 101 such that each of the supports 103 extend in a generally radial direction. Each of the supports 103 may extend in a radial direction that is perpendicular to the axis A of the consumable 100. Each of the supports 103 may take the form of a spoke or fin. Each of the supports 103 may be substantially planar. In some embodiments, the supports 103 may be non-planar, such as curved or corrugated.

The consumable 100 may further comprise at least one outlet 112 for permitting the aerosol generated within the consumable 100 to pass out of the consumable 100 from the at least one air gap 104. The at least one outlet 112 may be located at an axial end, for example, the mouth end 108, of the consumable 100.

In some embodiments, the outlet 112 may be formed by an open axial end, i.e. downstream mouth end 108, of the at least one air gap 104 between the outer tube 101 and the inner member 102. In some embodiments, the outlet 112 may be formed by a channel 113 in the component 111 located at an axial end 108 of the consumable 100, as shown in FIG. 2.

As shown in FIG. 1 and FIG. 2, the aerosol generating material 105 may extend along the length of the consumable 100. However, it will be appreciated that in alternative embodiments, the aerosol generating material 105 may only extend along a portion of the length of the consumable 100. In addition, the aerosol generating material 105 may extend circumferentially about the central axis A of the consumable 100. In some embodiments, the aerosol generating material 105 may extend substantially 360 degrees about the central axis A of the consumable 100. In some embodiments, the aerosol generating material 105 may extend partially about the central axis A of the consumable 100.

Furthermore, the condensation prevention layer 106 may extend along the length of the consumable 100. However, it will be appreciated that in an alternative embodiment, the condensation prevention layer 106 may only extend along a portion of the length of the consumable 100. In some embodiments, the condensation layer 106 may be located at least at the mouth end 108 of the consumable 100. In some embodiments, the condensation layer 106 may be located downstream of the aerosol generating material 105. Therefore, any aerosol generated in the at least one air gap 104 that would condense on a surface of the consumable 100 as it travels to the mouth end of the consumable 100 may instead come into contact with the condensation prevention layer 106.

In addition, the condensation prevention layer 106 may extend circumferentially about the central axis A of the consumable 100. In some embodiments, the condensation prevention layer 106 may extend substantially 360 degrees about the central axis A of the consumable 100. In some embodiments, the condensation prevention layer 106 may extend partially about the central axis A of the consumable 100.

In some embodiments, the condensation prevention layer 106 may comprise a porous containment material 106a. The porous containment material 106a may be an absorbent material. Thus, the porous containment material 106a that forms the condensation prevention layer 106 may absorb any aerosol that condenses as the aerosol travels along the at least one air gap 104 towards the mouth end of the consumable 100.

The porous containment material 106a may comprise one or more materials selected from the group consisting of: wadding, fleece, non-woven material, non-woven fleece, non-woven cellulose, woven material, knitted material, nylon, foam, cellulose acetate, polystyrene, polyester, polyester filament, polypropylene, and a blend of polyester and polypropylene.

In some embodiments, the condensation prevention layer 106 may comprise a hydrophobic surface 106b. The hydrophobic surface 106b may be configured to repel the aerosol generated in the at least one air gap 104. The hydrophobic surface 106b may be configured such that the contact angle between an aerosol droplet in contact with the hydrophobic surface 106b and the hydrophobic surface 106b is greater than 90 degrees. In some embodiments, the contact angle is greater than 150 degrees. Thus, aerosol may be prevented from condensing on the hydrophobic surface 106b.

As shown in FIG. 1 and FIG. 2, a first embodiment of the consumable 100 according to the present invention shown. The outer tube 101 comprises the condensation prevention layer 106. The outer tube 101 comprises a tube wall 121 having an inner surface 122. The tube wall 121 may be formed from, for example, but not limited to, cellulose, paper, polypropylene, metal/paper laminates such as alufoil paper, or a plastics material. The condensation prevention layer 106 may be located on the inner surface 122 of the tube wall 121. Thus, the condensation prevention layer 106 may comprise an innermost surface of the outer tube 101. That is, the condensation prevention layer 106 may comprise an inner surface 127. The inner surface 127 of the condensation prevention layer 106 may form the innermost surface of the outer tube 101. The innermost surface of the outer tube 101 may define an edge or boundary of the at least one air gap 103.

The inner member 102 may comprise the aerosol generating material 105. The inner member 102 may comprise a member wall 123 having an outer surface 124. The member wall 113 may be formed from, for example, but not limited to, cellulose, paper, polypropylene, metal/paper laminates such as alufoil paper, or a plastics material. The aerosol generating material 105 may be located on the outer surface 124 of the member wall 123. Thus, the aerosol generating material 105 may comprise an outermost surface of the inner member 102. That is, the aerosol generating material 105 may comprise an outer surface 126. The outer surface 126 of the aerosol generating material 105 may form the outermost surface of the inner member 102. The outermost surface of the inner member 102 may define an edge or boundary of the at least one air gap 103.

The inner member 102 may optionally further comprise a carrier 129. The carrier 129 is shown in FIG. 1 but has been omitted from FIG. 2. The aerosol generating material 105 may be affixed to the carrier 129. Thus, the carrier 129 may be located on the outer surface 124 of the member wall 123. The carrier 129 may be located on an inner surface 125 of the aerosol generating material 105. The aerosol generating material 105 may be an aerosol generating film provided on the carrier 129. However, it will be appreciated that the carrier 129 may be omitted, as shown in FIG. 2, and that the inner surface 125 of the aerosol generating material 105 may be in direct contact with the outer surface 124 of the member wall 123.

The at least one support 103 may extend between the outer tube 101 and the inner member 102. Thus, the at least one support 103 extends from the inner surface 127 of the condensation prevention layer 106 to the outer surface 126 of the aerosol generating material 105.

It will be appreciated that the condensation prevention layer 106 may comprise either a porous containment material 106a, as described above, a hydrophobic surface 106b, as described above, or a combination of a porous containment material 160a and a hydrophobic surface 106b.

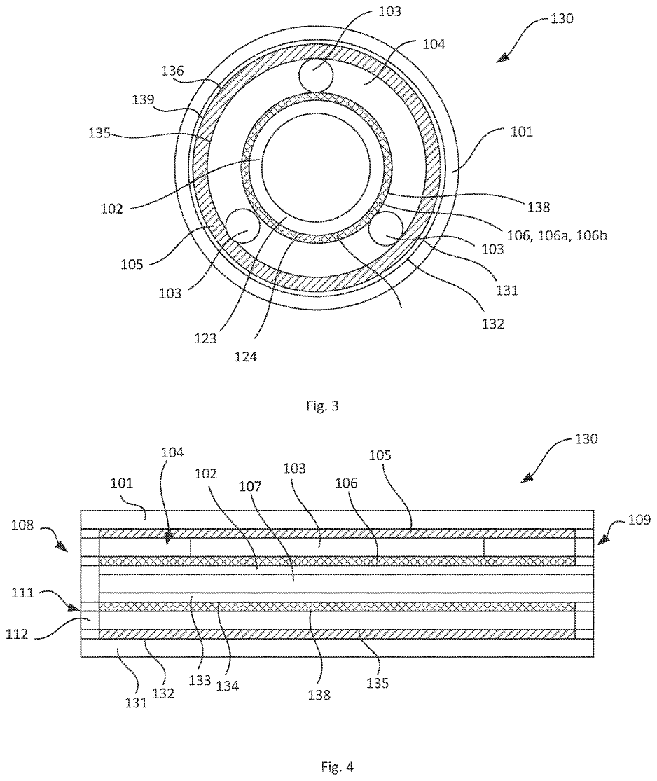

Referring now to FIG. 3 and FIG. 4, there are shown a schematic end view and a schematic cross-section side view of a second embodiment of a consumable 130 according to the present invention. The second embodiment of the consumable 130 is similar to the first embodiment of the consumable described above in relation to FIG. 1 and FIG. 2, and so a detailed description will be omitted herein. Furthermore, similar features and components will retain their terminology and reference numerals.

The main difference between the present embodiment and the embodiment shown in FIG. 1 and FIG. 2 is the location of the aerosol generating material 105 and the condensation prevention layer 106.

The outer tube 101 comprises an aerosol-generating material 105. The outer tube 101 comprises a tube wall 131 having an inner surface 132. The tube wall 131 may be formed from, for example, but not limited to cellulose, paper, polypropylene, metal/paper laminates such as alufoil paper, or a plastics material. The aerosol generating material 105 may be located on the inner surface 132 of the tube wall 131. Thus, the aerosol generating material 105 may comprise an innermost surface of the outer tube 101. That is, the aerosol generating material 105 may comprise an inner surface 135. The inner surface 135 of the aerosol generating material 105 may form the innermost surface of the outer tube 101. The innermost surface of the outer tube 101 may define an edge or boundary of the at least one air gap 103.

The outer tube 101 may optionally further comprise a carrier 139. The carrier 139 is shown in FIG. 3 but has been omitted from FIG. 4. The aerosol generating material 105 may be affixed to the carrier 139. Thus, the carrier 139 may be located on the inner surface 132 of the tube wall 131. The carrier 139 may be located on the outer surface 136 of the aerosol generating material 105. The aerosol generating material 105 may be an aerosol generating film provided on the carrier 139. However, it will be appreciated that the carrier 139 may be omitted, as shown in FIG. 4, and that the outer surface 136 of the aerosol generating material 105 may be in direct contact with the inner surface 132 of the tube wall 131.

The inner member 102 may comprise the condensation prevention layer 106. The inner member 102 may comprise a member wall 133 having an outer surface 134. The member wall 133 may be formed from, for example, but not limited to cellulose, paper, polypropylene, metal/paper laminates such as alufoil paper, or a plastics material. The condensation prevention layer 106 may be located on the outer surface 134 of the member wall 133. Thus, the condensation prevention material 106 may comprise an outermost surface of the inner member 102. That is, the condensation prevention material 106 may comprise an outer surface 138. The outer surface 138 of the condensation prevention material 106 may form the outermost surface of the inner member 102. The outermost surface of the inner member 102 may define an edge or boundary of the at least one air gap 103.

The at least one support 103 may extend between the outer tube 101 and the inner member 102. Thus, the at least one support 103 extends from the inner surface 125 of the aerosol generating material 105 to the outer surface 128 of the condensation prevention layer 106.

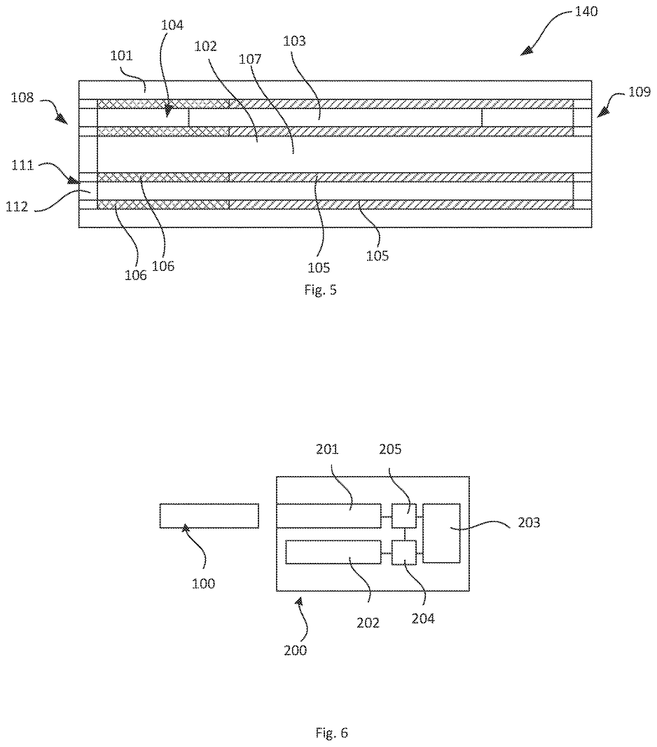

Referring now to FIG. 5, there is shown a schematic cross-sectional side view of a third embodiment of a consumable 140 according to the present invention. The third embodiment of the consumable 140 is similar to the first and second embodiments of the consumable 100, 130 described above in relation to FIGS. 1 to 4, and so a detailed description will be omitted herein. Furthermore, similar features and components will retain their terminology and reference numerals.

In the present embodiment, the outer tube 101 and the inner member 102 both comprise the aerosol generating material 105 and the condensation prevention layer 106. However, rather than the aerosol generating material 105 and condensation prevention layer 106 being layered upon each other on the outer tube 101 and the inner member 102, the aerosol generating material 105 and the condensation prevention layer 106 are located on different longitudinal portions of the consumable 100.

For example, in the illustrated embodiment, the aerosol generating material 105 is located on both the outer tube 101 and inner member 102 and extends from proximate the upstream end 109 of the consumable 100 towards the mouth end 108 of the consumable 140. In the present embodiment, the aerosol generating material 105 may extend along a portion of the length of the consumable 140. The aerosol generating material 105 may extend along about two-thirds of the length of the consumable 140.

Furthermore, in the illustrated embodiment, the condensation prevention layer 106 is located on both the outer tube 101 and inner member 102 and extends from proximate the mouth end 108 of the consumable 100 towards the upstream end 109 of the consumable 140. In the present embodiment, the condensation prevention layer 106 may extend along a portion of the length of the consumable 140. The condensation prevention layer 106 may extend along about two-thirds of the length of the consumable 140.

In the illustrated embodiment, the downstream end of the aerosol generating material 105 and the upstream end of the condensation prevention layer 106 are shown as being in contact with each other. However, it will be appreciated that in some embodiments, there may be a gap between the downstream end of the aerosol generating material 105 and the upstream end of the condensation prevention layer 106.

Furthermore, it will be appreciated that in some embodiments there may be more than one portion of aerosol generating material 105 and/or more than one portion of condensation prevention layer 106 aligned axially. The more than one portion of aerosol generating material 105 and/or condensation prevention layer aligned axially may be arranged alternately or in any other order.

In some embodiments, the consumable 100, 130, 140 may further comprise heating material that is heatable by penetration with a varying magnetic field to thereby heat the aerosol generating material 105. In some embodiments, the outer tube 101 may comprise the heating material. In some embodiments, the inner member 102 may comprise the heating material.

FIG. 6 illustrates a system comprising the consumable 100 and a non-combustible aerosol provision device 200. The non-combustible aerosol provision device 200 comprises an area 201 for receiving the consumable 100 and an aerosol generator 202. The aerosol generator 202 is configured to heat the aerosol-generating material A of the consumable 100 when it is received in the area 201 to generate an aerosol for inhalation by a user.

The non-combustible aerosol provision device 200 further comprises a power source 203, a controller 204, and a puff sensor 205. In use, a user inserts a consumable 100 distal end B first into the area for receiving the consumable 201 and activates the aerosol generator 202 to generate an aerosol for inhalation. The user may then draw on the mouth end C of the consumable 100 or, alternatively, on a mouthpiece (not shown) of the non-combustible aerosol provision device 200 to inhale the aerosol.

In the illustrated example, the consumable 100 and the non-combustible aerosol provision device 200 are configured so that the mouth end C protrudes from the area 201 for receiving the consumable 100 when fully inserted into the non-combustible aerosol provision device 200. Therefore, the mouth end C is available for placing between the lips of the user while the user holds the device.

The puff sensor 205 is configured to detect when a user is drawing on the mouth end C of the consumable 100 within the non-combustible aerosol provision device 200 and to send a signal to the controller 204 to activate the aerosol generator 202. Therefore, aerosol is generated concurrently with the user inhaling on the consumable. Alternatively, the non-combustible aerosol provision device 200 may be provided with a user interface-such as a button (not shown)—that the user may press to cause the activation of the aerosol generator 202.

The aerosol generator 202 comprises any suitable means for heating the aerosol generating material A of a consumable 100 received in said area 201 of the non-combustible aerosol provision device 200. Power for the aerosol generator 202 is provided by the power source 203, which in the illustrated example is an electrical power source 203, such as a battery 203.

In one example, the aerosol generator 202 comprises a magnetic field generator configured to generate a varying magnetic field that penetrates the area 201 for receiving the consumable 100. The varying magnetic field heats a susceptor that is placed within the area 201 for receiving the consumable 100. This example is used where the consumable 100 comprises a susceptor in thermal contact with the aerosol-generating material A. Therefore, when such a consumable 100 is placed within the non-combustible aerosol provision device 200 and the aerosol generator 202 is activated, a carrying magnetic field penetrates the susceptor of the consumable 100 and causes heating of aerosol-generating material A in thermal contact with the susceptor, generating an aerosol for inhalation by a user.

In another example, the aerosol generator 202 comprises a susceptor in thermal contact with the area 201 for receiving the consumable 100; and a magnetic field generator for generating a varying magnetic field that penetrates the susceptor. The varying magnetic field heats the susceptor by magnetic hysteresis. The susceptor in turn heats the area 201 for receiving the consumable Therefore, when a consumable 100 is placed within the non-combustible aerosol provision device 200 and the aerosol generator 202 is activated, a varying magnetic field penetrates the susceptor and causes heating of the area 201 in which the consumable 100 is received. The heat is transferred to the aerosol-generating material A of the consumable 100, generating an aerosol for inhalation by the user.

In such embodiments, the susceptor may be a wall of the area 201 for receiving the consumable 100 and the consumable 100 may be configured for direct contact with the wall for efficient heat transfer. Alternatively, the susceptor may comprise one or more protrusions (not shown) that upstand within the area 201 for receiving the consumable. Therefore, the susceptor may be directly locatable within the consumable 100.

In each of the above example susceptor configurations, it will be appreciated that the susceptor is configured for location in close proximity to the aerosol generating material A, but prevented from coming into direct contact with the aerosol generating material A.

In another example, the aerosol generator 202 comprises a material heatable by electrical conduction, the material being provided in thermal contact with the area 201 for receiving the consumable 100. Therefore, when a consumable is placed within the non-combustible aerosol provision device 200 and the aerosol generator 202 is activated, a current is passed through the material to heat the area 201 in which the consumable 100 is received. The heat is transferred to the aerosol-generating material A of the consumable 100, generating an aerosol for inhalation by the user. In such embodiments, the material may be a wall of the area 201 for receiving the consumable 100 and the consumable 100 may be configured for direct contact with the wall for efficient heat transfer.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the inventions as defined by the claims or limitations on equivalents to the claims, and that other embodiments may be utilized and modifications may be made without departing from the scope of the claims invention. Various embodiments of the invention may suitably comprise, consist of, or consist essentially of, appropriate combination of the disclosed elements, components, features, parts, steps, means, etc, other than those specifically described herein. In addition, this disclosure may include other inventions not presently claimed, but which may be in the future.

1. A consumable for use with a device for heating aerosol-generating material to volatilize at least one component of the aerosol-generating material, wherein the consumable comprises:
an outer tube;
an inner member inside the outer tube, and
at least one support that supports the inner member relative to the outer tube so that at least one air gap exists between the inner member and the outer tube;
wherein at least one of the inner member and the outer tube comprises aerosol-generating material that is heatable to generate aerosol in the at least one air gap, and
wherein the other of the inner member and the outer tube comprises a condensation prevention layer configured to prevent aerosol-generated in the at least one air gap from condensing on the other of the inner member and the outer tube.

2. The consumable according to claim 1, further comprising at least one outlet for permitting the aerosol to pass out of the consumable from the air gap.

3. The consumable according to claim 2, wherein the at least one outlet is at an axial end of the consumable.

4. The consumable according to claim 1, wherein the condensation prevention layer comprises a porous containment material.

5. The consumable according to claim 4, wherein the porous containment material comprises one or more materials selected from the group consisting of: wadding, fleece, non-woven material, non-woven fleece, woven material, knitted material, nylon, foam, polystyrene, polyester, polyester filament, polypropylene, and a blend of polyester and polypropylene.

6. The consumable according to claim 4, wherein the condensation prevention layer comprises a hydrophobic surface.

7. The consumable according to claim 4, wherein the condensation prevention layer comprises an innermost surface of the outer tube.

8. The consumable according to claim 4, wherein the condensation prevention layer comprises an outermost surface of the inner member.

9. The consumable according to claim 1, wherein the at least one support is located between the inner member and the outer tube.

10. The consumable according to claim 9, wherein the at least one support comprises an annular non-circular support between the inner member and the outer tube.

11. The consumable according to claim 10, wherein the at least one support comprises a folded or corrugated element between the inner member and the outer tube.

12. The consumable according to claim 1, wherein at least one of the inner member and the outer tube comprises a carrier, and the aerosol generating material is affixed to the carrier.

13. The consumable according to claim 12, wherein the aerosol-generating material is a film provided on the carrier.

14. The consumable according to claim 1, wherein at least one of the inner member and the outer tube is circular.

15. The consumable according to claim 14, wherein the inner member and the outer tube are concentric.

16. The consumable according to claim 1, wherein the inner member comprises an inner tube.

17. The consumable according to claim 16, wherein the inner tube is located around a passageway that opens at an axial end of the consumable so that a heating element for heating the aerosol generating material is insertable into the passageway in use.

18. The consumable according to claim 1, further comprising heating material that is heatable by penetration with a varying magnetic field to thereby heat the aerosol generating material.

19. The consumable according to claim 18, wherein at least one of the inner member and the outer tube comprises the heating material.

20. A system for heating aerosol-generating material to volatilize at least one component of the aerosol generating material, the system comprising:
the consumable of any one of the preceding claims, and
a device for heating the aerosol-generating material of the consumable to volatilize at least one component of the aerosol-generating material,
the device comprising a heating zone for receiving the consumable, and
a heater for causing heating of the aerosol generating material when the consumable is in the heating zone.

21. The system according to claim 20, wherein the device comprises a magnetic field generator for generating a magnetic field for penetrating the heating zone when the consumable is in the heating zone.
